(19) United States
(12) Patent Application Publication
(10) Pub. No.: US 2004/0252497 A1
(43) Pub. Date: Dec. 16, 2004

(54) Emergency flashlight

(75) Inventor: In-Teak Lim, Seoul (KR)

Correspondence Address: Garron M. Hobson, THORPE NORTH & WESTERN, LLP, P.O. Box 1219, Sandy, UT, 84091-1219, US

(73) Assignee: SAFELINE, Co. Ltd.

(21) Appl. No.: 10/728,414

(22) Filed: Dec. 5, 2003

(30) Foreign Application Priority Data
Jun. 11, 2003 (KR) 10-2003-0037638
Aug. 29, 2003 (KR) 20-2003-0027769

(51) Int. Cl. F21L 4/04

(52) U.S. Cl. 362/202; 362/200; 362/183; 362/201; 362/208

(57) ABSTRACT

This invention is related to a emergency flashlight comprises a flashlight body 110, and a holder 120 supporting the body 110: in which the body 120 includes a receiving section 111 storing small batteries 9 therein, a electric lighting section 112 equipped at upper side of the receiving section 111 and a lower covering section 113 equipped at lower side of the receiving section 111; the holder 120 includes a holder body section 121 fixed to a structure such as a wall, etc., a support section 122 extending from the holder body section 121 and supporting the flashlight body 110, a protecting section 123 horizontally extending from the holder body section 121 and covering the electric lighting section 112 of the flashlight body 110, and a cap 124 pivotally supported by opposite ends of the support section 122 through a hinge shaft 124a; and on the receiving section 111 included in the flashlight body 110, a transversely lengthy through slot 111a is formed, and on the support section 122 of the holder, a partition plate 122a is placed and extended in a location corresponding to the through slot 111a.

This application claims priority to Korean Patent Application No. 10-2003-0037638 filed Jun. 11, 2003; and Korean utility Model Application No. 20-2003-0027769 filed Aug. 29, 2003.

### BACKGROUND OF THE INVENTION

1. Technical Field of the Invention

This invention relates to an emergency flashlight, in particular to the emergency-flashlight having a flashlight body stably supported by a holder and a cap designed to be openable and closable relative to the holder, preventing the flashlight body from theft and loss.

2. Description of Related Art and Background of the Invention

Most emergency flashlights are kept in a chest of drawers located within rooms or living rooms without being held on a holder. The emergency flashlights are also constructed to be manipulatively turned on during an emergency situation and to be manipulatively turned off during a normal situation.

The emergency flashlights must be held by itself in a readily visible location in the rooms, for a prompt use, as a fire extinguisher is readily useful in the event of an emergency such as a power failure or disaster. However, the emergency flashlights can not be easily useful in such emergency, because the flashlights are placed in such a invisible location as the chest of drawer. Although user knows a location on which the flashlights are placed, it is impossible for user to find readily out the flashlights in the event of such emergency. In addition, although user finds easily out the flashlights, it is impossible for the user to readily turn on the flashlights.

### BRIEF SUMMARY OF THE INVENTION

An object of this invention is to provide an emergency flashlight having a flashlight body which is attached to a wall-affixed holder and turned on when it is taken out of the holder, causing user to find out the flashlight body, and a cap designed to be openable and closable relative to the holder, preventing the flashlight body from theft and loss.

A further object of this invention is provide a emergency flashlight of which a flashlight body has a luminous layer coated or adhered on a center portion thereof, causing user to find easily out a flashlight body placed location in the event of such an emergency situation as a power failure or disaster.

In order to achieve the above object, the emergency flashlight according to the present invention comprises a flashlight body, and a holder supporting it: in which the flashlight body includes a receiving section storing small batteries therein, a electric lighting section equipped at upper side of the receiving section and a lower covering section equipped at lower side of the receiving section; the holder includes a holder body section fixed to a structure such as a wall, etc., a support section extending from the holder body section and supporting the flashlight body, a protecting section horizontally extending from the holder body section and covering the electric lighting section of the flashlight body, and a cap pivotally supported by opposite ends of the support section through a hinge shaft; and on the receiving section included in the flashlight body, a transversely lengthy through slot is formed, and on the support section of the holder, a partition plate is placed and extended in a location corresponding to the through slot, so that the partition plate is inserted into the receiving section via the through slot of the receiving section and interposed between the batteries, interrupting electrical contact between the batteries when the flashlight body is fitted in the holder.

### BRIEF DESCRIPTION OF THE DRAWINGS

FIG. 1 is an assembled perspective view of an emergency flashlight according to a first embodiment of the present invention;

FIG. 2 is an exploded perspective view of the emergency flashlight of FIG. 1;

FIG. 3 is a front view of a flashlight body taken out of a holder of the emergency flashlight of FIG. 1;

FIG. 4 is a rear view of the holder of the emergency flashlight of FIG. 1 when the flashlight body is taken out of the holder;

FIG. 5 is a portion cut-away elevation view of the assembled emergency flashlight of FIG. 1;

FIG. 6 is an assembled perspective view of an emergency flashlight according to a second embodiment of the present invention;

FIG. 7 is an exploded perspective view of the emergency flashlight of FIG. 6;

FIG. 8 is a rear view of a flashlight body taken out of a holder of the emergency flashlight of FIG. 6;

FIG. 9 is a front view of the holder of the emergency flashlight of FIG. 6 when the flashlight body is taken out of the holder; and

FIG. 10 is a portion cut-away elevation view of the assembled emergency flashlight of FIG. 6.

### DETAILED DESCRIPTION OF PREFERRED EMBODIMENTS

A preferred embodiment of an emergency flashlight according to the present invention will be hereinafter described in detail with reference to the attached drawings.

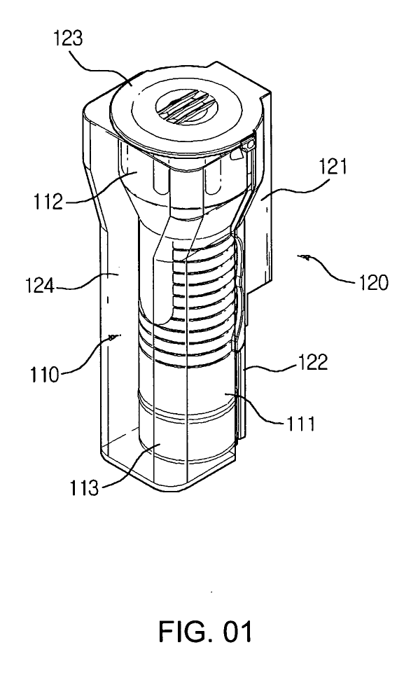

Referring to FIGS. 1 to 5, there is shown an emergency flashlight according to a first preferred embodiment of the present invention.

An emergency flashlight according to the first preferred embodiment comprises a flashlight body 110, and a holder 120 holding it, in which the holder is provided with a cap 124 designed to be openable and closable relative to it.

The flashlight body 110 includes a receiving section 111 for storing a plurality of small batteries 9, a electric lighting section 112 equipped at upper side of the receiving section 111, and a lower covering section 113 equipped at lower side of the receiving section 111

The holder 120 includes a holder body section 121 fixed to a structure such as a wall, etc., a support section 122 extending from the holder body section 121 and supporting the flashlight body 110, a protecting section 123 horizontally extending from the holder body section 121 and covering the electric lighting section 112 of the flashlight body 110, and the cap 124 pivotally supported by opposite ends of the support section 122 through a hinge shaft 124a.

In the first embodiment, four small batteries are received in the receiving section 111. The electric lighting section 112 is screwed-fitted with one end of the receiving section 111, and the lower covering section 113 is screwed-fitted with one another end of the receiving section 111. The small batteries 9 received in the receiving section 111 may be taken out of the receiving section, after the lower covering section 113 is disengaged from the receiving section.

In a read side of the receiving section 111, a hook member 114 giving good portability for user after the flashlight body 110 is taken out of the holder 120 is formed.

For the good portability, the hook member 114 may be of elastic material, and be hanged on a belt, a handle ring of hand-beg, or etc.

The electric lighting section 112 is powered and turned on through the batteries 9 received in the receiving section 111.

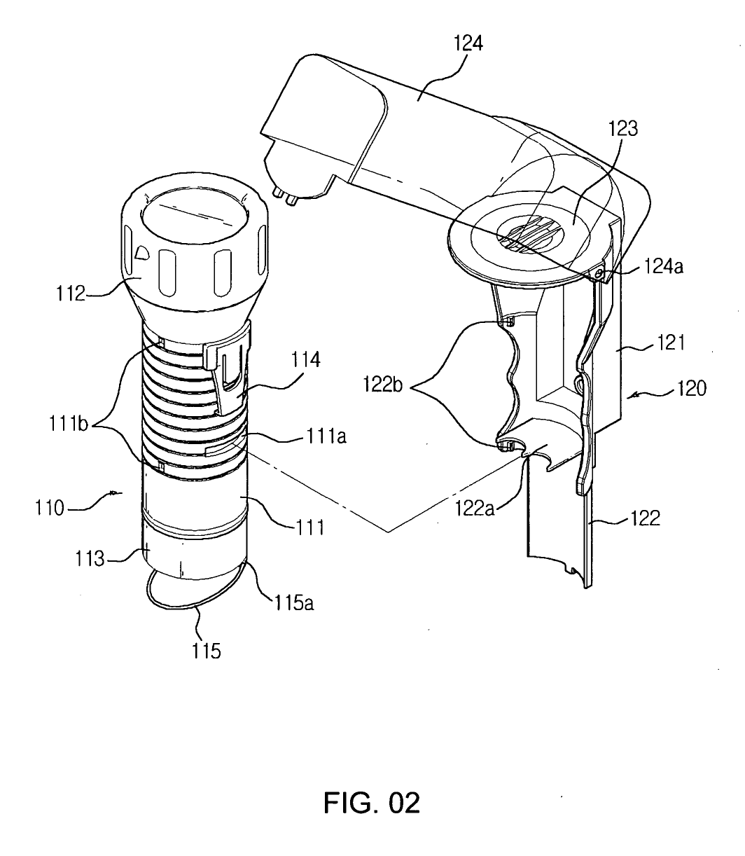

As shown in FIG. 2, in a lower end of the lower covering section 113, a ring member 115 pivotally supported by a hinge shaft 115a mounted to a lower end of the receiving section 111, is formed so that the flashlight body 110 is hanged on a peg, a clothes hanger or etc., after the flashlight body 110 is taken out of the holder 120.

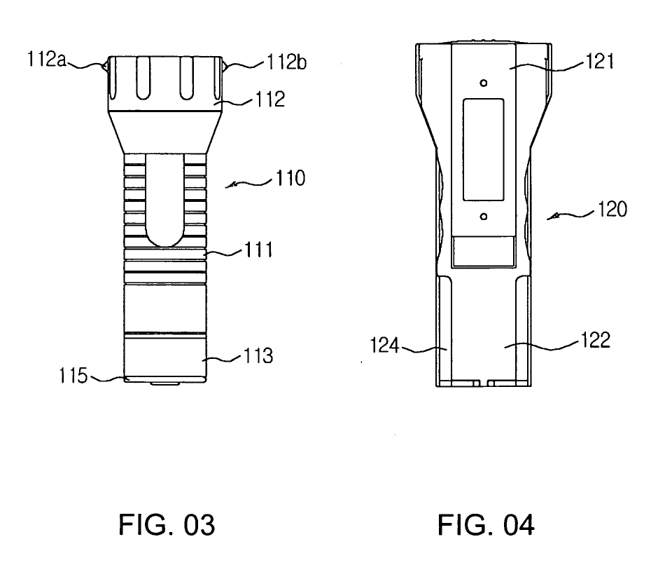

As shown in FIG. 3, a glass cutting edge 112a is attached to a left side of the electric lighting section 112, and a hammer piece 112b of a gimlet shape made of alloy steel or stainless-steel material is attached to a right side of the electric lighting section 112. The glass cutting edge 112a and a hammer piece 112b cause user to readily perform a cutting, striking and breaking relative to a glass during emergency situation.

The holder body section 121 may be fixed to such a structure as a wall, etc., by means of a peg, a bonding tape or etc.

As shown in FIG. 4, the support section 122 extends downward by the same length as a longitudinal length of the flashlight body 110, and has a shape corresponding to the flashlight body 110. In the first embodiment, the flashlight body 110 has a cylindrical shape and the support section 122 has such a shape that it can cover the flashlight body 110.

It is preferable that the cap 124 is made of transparent acryl material in order for the flashlight body 110 held within the holder to be readily found out. Also, the cap 124 may be open and close to the holder by pivoting around a hinge shaft 124a. For using the flashlight body 110, the cap 124 must be open to the holder and then the flashlight body 110 be separated from the support section 122 by a user.

It is preferable that the cap 124 has such a shape and size that the cap generally covers and protects the flashlight body 110 and also a lower end of the cap abuts with a lower end of the support section 122.

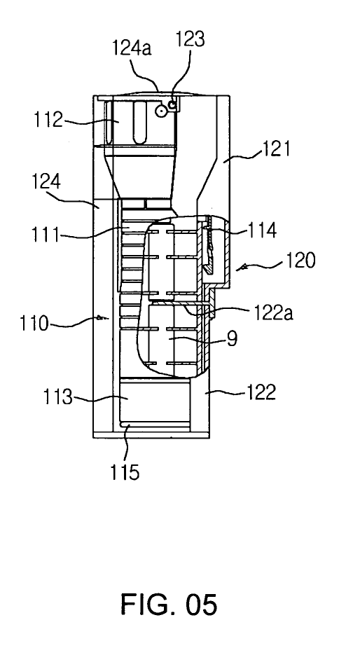

As shown in FIG. 2 and FIG. 5, on an approximate center portion of outer periphery surface of the receiving section 111 included in the flashlight body 110, a transversely lengthy through slot 111a is formed, and on the support section 122 of the holder 120, a partition plate 122a is placed in a location corresponding to the through slot 111a and extends toward the through slot.

As shown in FIG. 5, the partition plate 122a is interposed between the batteries 9 via the through slot 111a of the receiving section 111, interrupting electrical contact between the batteries. Therefore, it is possible that the flashlight body 110 is turned on when it is separated from the holder 120 and the partition plate 122a is escaped between the batteries 9, and turned off when it is fitted in the holder 120 and the partition plate 122a is interposed between the batteries 9 without a separate switch.

Also, the batteries are not contacted to each other during the flashlight body 110 being held in the holder 120, preventing the batteries from discharge and enhancing life of the batteries.

In the emergency flashlight of the first embodiment, the support section 122 of the holder includes a pair of projections 122b on each of left and right sides, and the receiving section 111 of the flashlight body includes a pair of concave portions 111b having such a shape and size that they are fitted with the a pair of projections 122b on a outer periphery surface, respectively, in order to surely fit the flashlight body 110 and the holder 120 to each other. Therefore, the flashlight body 110 and the holder 120 may be dismountably fitted to each other by elastic force between the pair of projections 122b and the pair of concave portions 111b.

Therefore, in the emergency flashlight according to the first embodiment, it is possible that the partition plate 122a is inserted into the through slit 111a of the flashlight body as well as the projections 122b of the support section are inserted into the concave potions 111b, respectively, in order to the flashlight body 110 and the holder 120 may be dismountably fitted to each other.

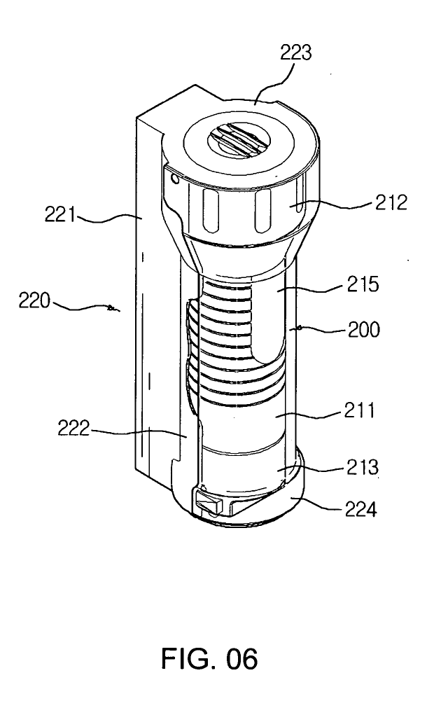

Referring to FIGS. 6 to 10, there is shown an emergency flashlight according to a second preferred embodiment of the present invention.

In description about the emergency flashlight according to a second preferred embodiment, descriptions about members as configured as is described with respect to the emergency flashlight according the first embodiment will be omitted hereinafter and the members similar to members of the first embodiment are indicated as the same reference numbers or the like numbers hereinafter.

In such a manner that the emergency flashlight according to the second embodiment is configured as described in the above, an emergency flashlight according to the second embodiment comprises a flashlight body 210, and a holder 220 holding it 210, in which the holder is provided with a cap 224 designed to be openable and closable relative to it.

The flashlight body 210 includes a receiving section 211 for storing small batteries 9, a electric lighting section 212 equipped at upper side of the receiving section 211, and a lower covering section 213 equipped at lower side of the receiving section 211.

The holder 220 includes a holder body section 221 fixed to such a structure as a wall, etc., a support section 222 extending from the holder body section 221 and supporting the flashlight body 210, a protecting section 223 horizontally extending from the holder body section 221 and covering the electric lighting section 212 of the flashlight body 210, and a cap 224 pivotally supported by opposite ends of the support section 222 through a hinge shaft 224a.

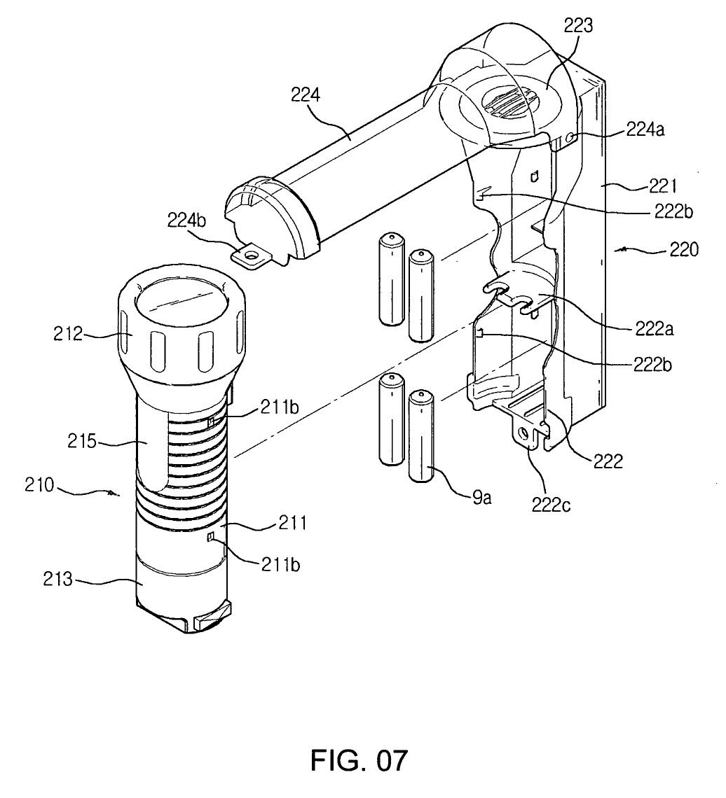

As shown in FIGS. 6 and 7, a luminous layer 215 is adhered on a front center portion of the receiving section 211 directed toward a front side when the flashlight body 210 is held in the holder 220, i.e., a center portion of the receiving section 211 visible from the outside. The luminous layer 215 may be attached to the receiving section by coating or adhering process, and made of a known material that can receive and store a light at normal times and emit the light by itself in the dark for hours. In the emergency flashlight according to the second embodiment, the material of the luminous layer is of a light storing material that is able to emit a light for about 20 minutes and can be visible from the 10 miter distances, but the present invention is not limited to the above.

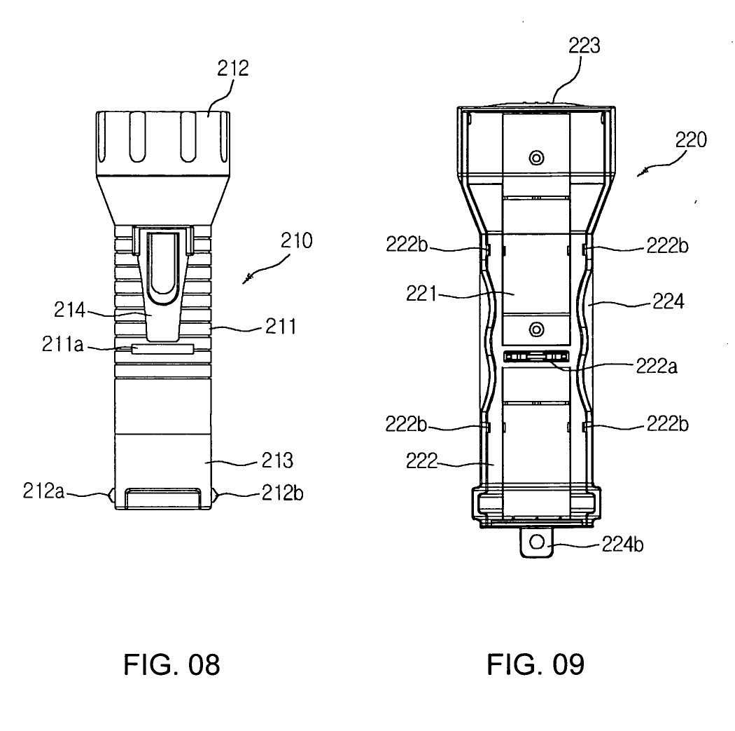

As shown in FIG. 8, in the second embodiment, a glass cutting edge 212a is attached to a one side of a lower end of the lower covering section 213, and a hammer piece 212b made of alloy steel or stainless-steel material is attached to a other side of the lower end of the lower covering section 213. The glass cutting edge 212a and a hammer piece 212b are readily useful in cutting, striking and breaking a glass during emergency situation.

The flashlight body 210 stores batteries and the lower covering section 213 is heavier than the electric lighting section 212, enabling the hammer piece to give a stronger striking force to the glass when the glass is hit by the hammer piece with the same striking force. Such arrangement enable a easily breaking member such as a bulb included in the electric lighting section 212 to be prevented from damage.

In a read side of the receiving section 211, a hook member 214 giving good portability for user after the flashlight body 210 is taken out of the holder 220, is formed.

In the second embodiment, an inner space of the holder body section 221 to be fixed to such a structure as a wall, etc., by means of a peg, a bonding tape or etc., receives the same spare batteries 9a as batteries 9 charged within the flashlight body 210. Thereafter, although the batteries charged within the flashlight body are run down, it is possible to use continuously the flashlight body by the spare batteries instead of the run down batteries being charged into the flashlight body.

The cap 224 generally covers and protects the flashlight body 210. For preventing the flashing body from theft and loss, it is preferable that a lower end of the cap 224 and a lower end of the support section 222 a re locked by locking means such as a small size lock or soldering process, in order for them not to be unlock easily. For such a construction, it is preferable that projections 222c, 224b having a perforate hole are formed in a lower end of the cap 224 and a lower end of the support section 222, respectively, in order for the locking means to be mounted thereto. The locking means is not in detail described hereinafter, because any known various lockers may be substituted for the locking means.

In case that the cap 224 is locked to the support section 222 through the locking means or soldering process, it is preferable that the cap is such constructed that a preliminary process, for example, a process that a plurality of grooves are in advance formed on its surface, in order that although the cap 224 is hit by a little force, the cap is broken easily and the flashlight body is taken out of the holder easily. The plurality of grooves formed on the surface of the cap, although the grooves are not shown in the above Figs., in such a manner that the grooves have a shape of a dotted line or a solid line and are arranged in a row or two rows through all the area or a portion area of the surface.

For preventing the flashlight body from theft, it is preferable that the lower end of the cap 224 and the lower end of the support section 222 to be abutted and locked to each other is made of a conductible material and a circuit is formed on their surface, in order to sound an alarm when they are separated from each other

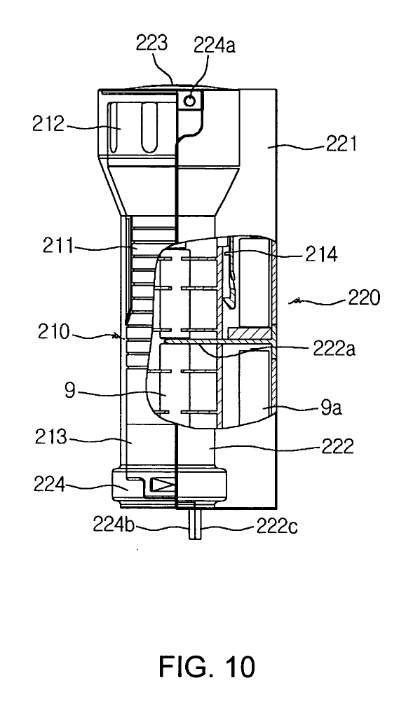

As is in the first embodiment, in the second embody, on an approximate center portion of the receiving section 211 included in the flashlight body 210, a transversely lengthy through slot 211a is formed, on the support section 222 of the holder, a partition plate 222a is placed in a location corresponding to the through slot 211a and extends toward the through slot (refer to FIG. 7 and FIG. 10).

Also, in the emergency flashlight of the second embodiment, the support section 222 of the holder includes a pair of projections 222b on each of left and right sides, and the receiving section 211 of the flashlight body includes a pair of concave portions 211b having such a shape and size that they are fitted with the a pair of projections 222b on a outer periphery surface, respectively, in order to surely fit the flashlight body 210 and the holder 220 to each other. Therefore, the flashlight body 210 and the holder 220 may be dismountably fitted to each other by elastic force between the pair of projection 222b and the pair of concave portions 211b.

Also, it is preferable that the flashlight body 210 includes means for turning on it when it is separated from the holder 220 and includes a speaker (not shown) for sounding an alarm by a separate circuit. It is possible to sound an alarm for a set time or to stop the sound of alarm by a separate switch at user's option.

The emergency flashlights according to the foregoing preferred embodiments, enable the flashlight body to be placed on a desired area such as a visible wall, etc. through the holder, the user to find easily out the flashlight body, and the flashlight body to be turned on as soon as it is taken out of the holder without any help of a separate switch. Thereafter, it is possible for user to find easily out the flashlight body and for flashlight body to be turned on when it is taken out of the holder, causing the user to rapidly meet the emergency situation.

Also, the emergency flashlight according to the embodiment enables the sound of alarm to be generated when the flashlight body is taken out of the holder, causing the flashlight body to be prevented from thief, enabling the user to find easily out the flashlight body.

1. An emergency flashlight comprises a flashlight body 110 or 210, and a holder 120, 220 supporting said body 110 or 210:
in which said body 120 or 210 includes a receiving section 111 or 211 storing small batteries 9 therein, a electric lighting section 112 or 212 equipped at upper side of said receiving section 111 or 211 and a lower covering section 113 or 213 equipped at lower side of said receiving section 111 or 212;
said holder 120 or 220 includes a holder body section 121 or 221 fixed to such a structure as a wall, etc., a support section 122 or 222 extending from said holder body section 121 or 212 and supporting said flashlight body 110 or 210, a protecting section. 123 or 223 horizontally extending from said holder body section 121 or 221 and covering said electric lighting section 112 or 212 of said flashlight body, and a cap 124 or 224 pivotally supported by opposite ends of said support section 122 or 222 through a hinge shaft 124a or 224a; and
on said receiving section 111 or 211 included in said flashlight body 110, a transversely lengthy through slot 111a or 211a is formed, and on said support section 122 or 222 of said holder, a partition plate 122a or 222a is placed and extended in a location corresponding to said through slot 111a or 211a, so that said partition plate 122a or 222a is inserted into said receiving section via said through slot 111a of said receiving section 111 and interposed between said batteries 9, interrupting electrical contact between said batteries 9 when said flashlight body it is fitted in said holder 120.

2. The emergency flashlight as claimed in claim 1, wherein a glass cutting edge 112a or 212a is attached to one side of said flashlight body 110 or 210, and a hammer piece 112b or 212b is attached to other side of said flashlight body 110 or 210.

3. The emergency flashlight as claimed in claim 1, wherein in a read side of said receiving section 111 or 211, a hook member 114 or 214 giving good portability for a user after said flashlight body 110 or 210 is taken out of said holder 120 or 220 is formed; and
said cap 124 or 224 is made of transparent acryl material in order for said flashlight body 110 or 210 held within said holder to be found easily out and has such a shape and size that said cap generally covers and protects said flashlight body 110 or 210.

4. The emergency flashlight as claimed in claim 1, wherein in a lower end of said lower covering section 113, a ring member 115 pivotally supported by a hinge shaft 115a is formed so that said flashlight body 110 is hanged on a wall-fixed peg, a clothes hanger or etc., after said flashlight body 110 is taken out of said holder 120.

5. The emergency flashlight as claimed in claim 1, wherein a luminous layer 215 is adhered on a front center portion of said receiving section 211 in order to emit a light by itself in the dark for hours.

6. The emergency flashlight as claimed in claim 1, wherein an inner space of said holder body section 221 receives the same spare batteries 9a as batteries 9 charged within said flashlight body 210.

7. The emergency flashlight as claimed in claim 1, wherein for preventing said flashing body from theft, projections 222c, 224b having a perforate hole are formed in a lower end of the cap 224 and a lower end of said support section 222, respectively; in order for a locking means to be mounted thereto; and
in case that said cap 224 is locked to said support section 222 through said locking means, a plurality of grooves are formed on surface of cap 224 in order that said cap is broken easily.

8. The emergency flashlight as claimed in claim 1, wherein said support section 122 or 222 of the holder includes a pair of projections 122b or 222b on each of left and right sides, and said receiving section 111 or 211 of said flashlight body includes a pair of concave portions 111b or 211b having such a shape and size that they are fitted with said pair of projections 122b or 222b on a outer periphery surface, respectively, in order to dismountably fit said flashlight body 110 or 210 and said holder 120 or 220 to each other, by elastic force between said pair of projections 122b or 222b and said pair of concave portions 111b or 211b.

9. The emergency flashlight as claimed in claim 1, wherein said lower end of said cap 124 or 224 and said lower end of said support section 122 or 222 to be abutted and locked to each other are made of a conductible material and a circuit is formed on their surface, in order to sound an alarm when they are separated from each other.

10. The emergency flashlight as claimed in claim 1, wherein said flashlight body 110 or 210 includes a speaker for sounding an alarm when said flashlight 110 or 210 is separated from said holder 120 or 220.
